(19) United States
(12) Patent Application Publication
(10) Pub. No.: US 2007/0171324 A1
(43) Pub. Date: Jul. 26, 2007

(54) Light condensers for LCDS

(75) Inventors: Kang-Woo Lee, Seoul (KR); Joong-Hyun Kim, Gyeonggi-do (KR); In-Sun Hwang, Gyeonggi-do (KR)

Correspondence Address: David W. Heid;MacPHERSON KWOK CHEN & HEID LLP, Suite 226, 1762 Technology Drive, San Jose, CA, 95110, US

(73) Assignee: Samsung Electronics Co., Ltd.

(21) Appl. No.: 11/639,493

(22) Filed: Dec. 14, 2006

(30) Foreign Application Priority Data
Jan. 26, 2006 (KR) 2006-8432

(51) Int. Cl. G02F 1/1335

(52) U.S. Cl. 349/61

(57) ABSTRACT

A light condenser for an LCD includes a base layer, a condensing layer and a lower surface-treated layer. The condensing layer is disposed on the base layer and has a condensing pattern formed therein. The lower surface-treated layer is disposed below the base layer and has a plurality of protrusions extending downwardly therefrom. Each of the protrusions has a substantially round shape. The novel light condenser enables the number of optical elements needed in a display apparatus to be reduced, thereby reducing LCD manufacturing costs. Additionally, the light condenser prevents a mutual scratching and adhesion problem between the condenser and a diffusing plate of the LCD, thereby improving the quality of the image produced by the display.

### RELATED APPLICATIONS

This application claims priority of Korean Patent Application No. 2006-8432, filed Jan. 26, 2006, the entire contents of which are incorporated herein by reference.

### BACKGROUND

This invention generally relates to light condensers for liquid crystal displays (LCDs) and methods for manufacturing and installing the condensers in LCDs. More particularly, the present invention relates to manufacturing and using LCD light condensers that are less expensive to manufacture and that provide better resistance to a mutual abrasion and adhesion problem between the condenser and a diffusing plate of the LCD.

Information devices, such as mobile phones, notebook computers, computer monitors, and the like, typically employ some form of a display device for producing a viewable image. Examples of such display devices include cathode-ray tubes (CRTs), plasma display panels (PDPs), and the like. Recently, liquid crystal displays (LCDs) have come to be widely used for this application.

A “transmissive” type of LCD requires some form of a backlight assembly, since its display panel is not self-emissive. A conventional LCD backlight assembly typically includes a plurality of lamps for generating light, a diffusing plate disposed on the lamps to diffuse the light, and a plurality of optical sheets disposed on the diffusing plate to improve the optical characteristics of the light. Examples of the optical sheets used include structures having a diffusing sheet, a condensing sheet and a reflective polarizing sheet, which are deposited, one on top of the other, and structures having three deposited diffusing sheets, and so on.

Recently, structures having only a single condensing sheet and without the other optical sheets have been developed in an effort to reduce manufacturing costs. However, when a condensing sheet is disposed directly on a diffusing plate, it can cause scratches to be formed on the condensing sheet and/or the diffusing plate. Additionally, any adhesion between the condensing sheet and the diffusing plate causes a distortion of the light passing through the interface between the condensing sheet and the diffusing plate, which results in a deterioration of the quality of the image produced by the display.

### BRIEF SUMMARY

In accordance with the exemplary embodiments thereof described herein, the present invention provides a light condenser for LCDs that can be manufactured at a lower cost and that is more resistant to the problem of mutual scratching and adhesion between the condenser and the diffusing plate described above, as well as methods for manufacturing the condenser and using it in an LCD.

In an exemplary embodiment thereof, a light condenser for an LCD includes a base layer, a condensing layer and a lower surface-treated layer. The condensing layer is disposed on the base layer and has a condensing pattern formed therein. The lower surface-treated layer is disposed under the base layer and has a plurality of protrusions extending downwardly therefrom. Each of the protrusions has a substantially round shape.

In one exemplary embodiment, the ratio of the height of the protrusions to the width of the protrusions is from about 0.01 to about 0.06. The height of the protrusions is from about 1 μm to about 10 μm. The density of the protrusions is from about 450/mm² to about 1000/mm². The protrusions may be spaced apart from each other at regular or irregular intervals.

The base layer, the condensing layer and the lower surface-treated layer comprise a transparent material, e.g., polyethylene terephthalate (PET) and/or polycarbonate (PC).

In another aspect of the present invention, an exemplary embodiment of a method for manufacturing an LCD light condenser is provided. In the exemplary method, a condensing layer having a plurality of prisms is formed on a base layer. A lower surface-treated layer having a plurality of protrusions extending downwardly therefrom is formed under the base layer. Each of the protrusions is substantially round in shape. The lower surface-treated layer may be formed, for example, by either a sand-blasting process or a photolithography process.

In another aspect of the present invention, an LCD is provided that includes a light source for generating light, a diffusing plate disposed on the light source, a light condenser disposed on the diffusing plate, and a display panel disposed on the condenser for displaying an image. The light condenser includes a base layer, a condensing layer and a lower surface-treated layer. The condensing layer is disposed on the base layer and has a condensing pattern formed therein. The lower surface-treated layer is disposed under the base layer and has a plurality of protrusions extending downwardly therefrom. Each of the protrusions is substantially round in shape. In one exemplary embodiment, the ratio of the height of the protrusions to the width of the protrusions is from about 0.01 to about 0.06. The height of the protrusions is from about 1 μm to about 10 μm. The density of the protrusions may be from about 450/mm² to about 1000/mm².

In some embodiments, the display apparatus may further include a protective sheet disposed between the light condenser and the display panel.

In the above exemplary embodiments, the LCD light condenser of the invention can perform the functions of several other optical elements. Therefore, the number of optical elements needed in an LCD can be reduced, thereby reducing display manufacturing costs. Additionally, the light condenser is more resistant to the problem of mutual scratching and adhesion between the condenser and the diffusing plate, thereby improving the quality of the image produced by the display.

A better understanding of the above and many other features and advantages of the light condensers of the present invention and the methods for their manufacture and use in LCDs may be obtained from a consideration of the detailed description of some exemplary embodiments thereof below, particularly if such consideration is made in conjunction with the appended drawings, wherein like reference numerals are used to identify like elements illustrated in one or more of the figures thereof.

### BRIEF DESCRIPTION OF THE DRAWINGS

FIG. 1 is an exploded perspective view of an LCD incorporating an exemplary embodiment of a light condenser in accordance with the present invention;

FIG. 2 is a cross-sectional view of the LCD of FIG. 1;

FIG. 3 is a perspective view of the exemplary light condenser of the LCD of FIG. 1;

FIG. 4 is a perspective view of a lower surface of the light condenser of FIG. 3;

FIG. 5 is a cross-sectional view of the light condenser of FIG. 3; and,

FIG. 6 is an enlarged, partial cross-sectional view of a protrusion of the light condenser of FIG. 5.

### DETAILED DESCRIPTION

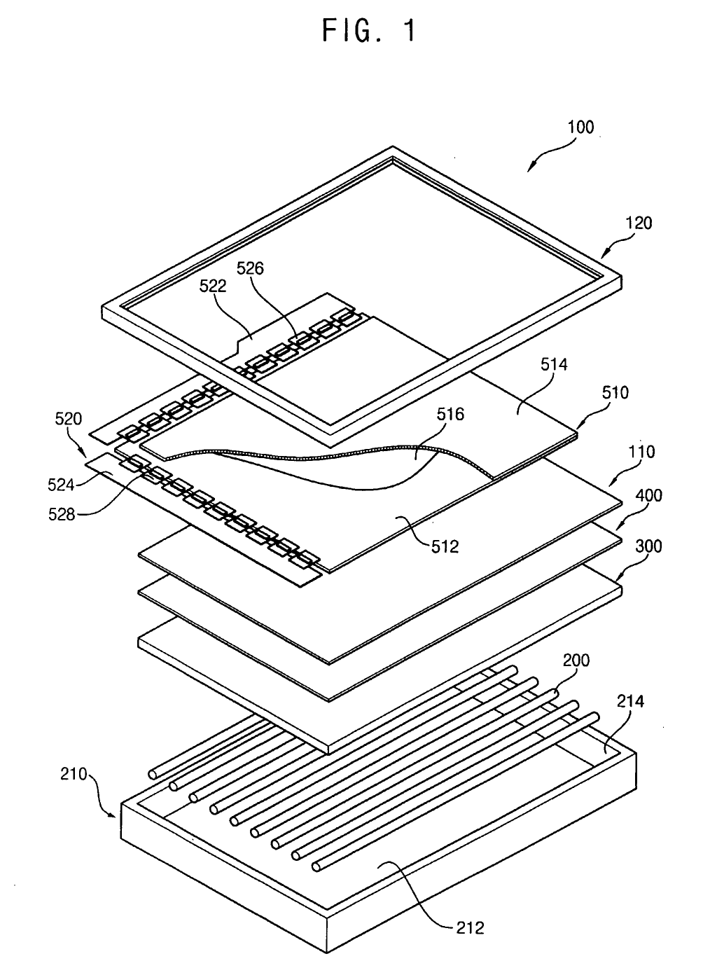

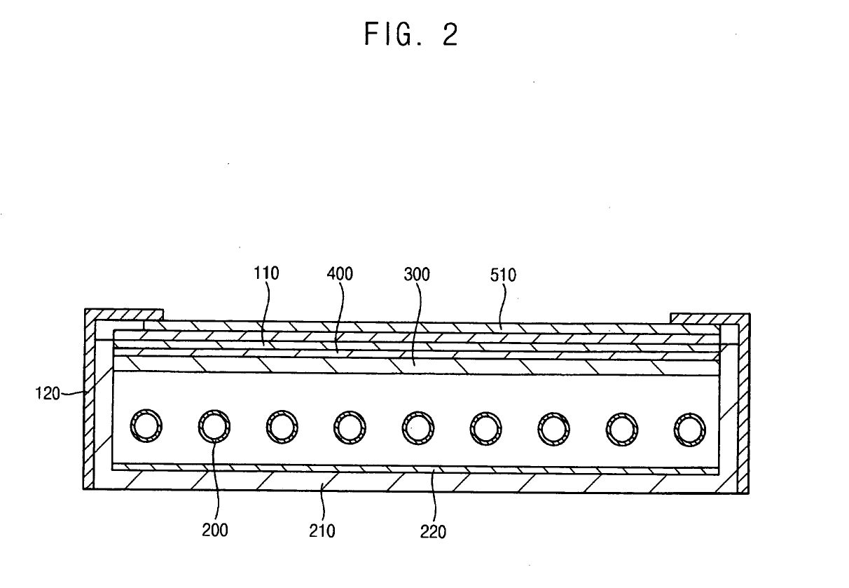

FIG. 1 is an exploded perspective view of an LCD 100 incorporating an exemplary embodiment of a light condenser 400 in accordance with the present invention, and FIG. 2 is a cross-sectional view thereof. The LCD 100 includes a light source 200, a diffusing plate 300, the light condenser 400 and a display panel 510.

The light source 200 is received in a receiving container 210. The light source 200 generates light in response to a driving voltage applied to it from an external inverter (not shown) connected to the light source 200. The light source 200 includes a plurality of cold cathode fluorescent lamps (CCFL) having a substantially cylindrical shape. Alternatively, the light source 200 may include a plurality of external electrode fluorescent lamps (EEFL). In an alternative embodiment, the light source 200 may be bent into a ‘U’ shape.

The receiving container 210 includes a bottom portion 212 and a side portion 222 that extends from a peripheral portion of the bottom portion 212 to form a receiving space, and may be formed of, for example, a strong, stiff metal alloy.

The diffusing plate 300 is disposed on the light source 200. The diffusing plate 300 diffuses the light emitted from the light source 200 to increase the uniformity of the luminescence of the light. The diffusing plate 300 is plate-shaped, has a selected thickness, and is spaced apart from the light source 200 by a selected distance. The diffusing plate 300 is comprised of a transparent material to transmit light and a diffuser to diffuse the light. The diffusing plate 300 may comprise, for example, polymethylmethacrylate (PMMA).

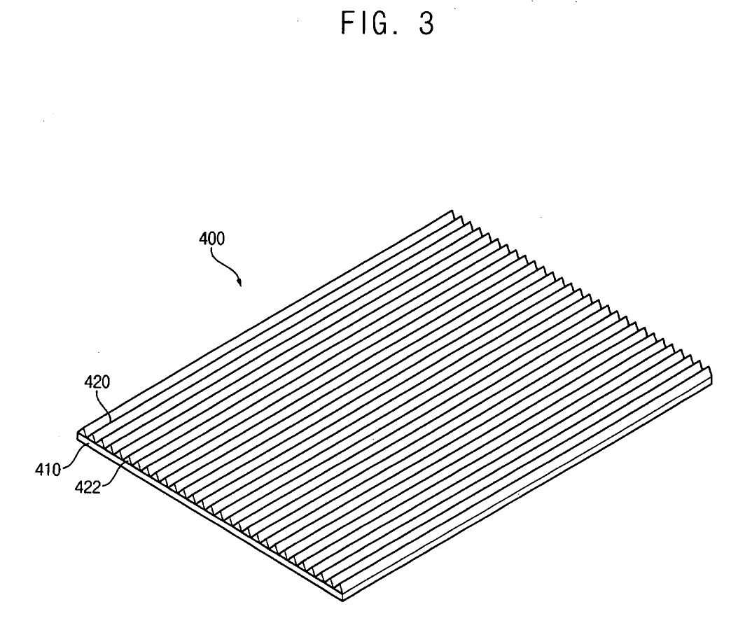

The exemplary light condenser 400 is disposed directly on the diffusing plate 300, and functions to condense the light diffused by the diffusing plate 300 so as to increase the brightness of the LCD 100. The condenser 400 includes a condensing layer and a lower surface-treated layer. The condensing layer functions to condense the light emitted by the diffusing plate, and the lower surface-treated layer functions to reduce the problem of mutual scratching and adhesion between the condenser 400 and the diffusing plate 300 in a manner described in more detail below with reference to FIGS. 3-6.

As illustrated in FIGS. 1 and 2, the display panel 510 is disposed above the light condenser 400. The display panel 510 forms and displays an image using the light passing through the condenser 400. The display panel 510 includes a first substrate 512, a second substrate 514 combined in spaced opposition with the first substrate 512, and a layer of a liquid crystal material 514 interposed between the first and second substrates 512 and 514.

The first substrate 512 includes a plurality of thin-film transistors (TFTs) that are arranged in a matrix configuration. The second substrate 514 includes a plurality of film-like red, green and blue color filters that produce light of the respective colors from the light passing through them.

The display apparatus 100 includes a driving circuit part 520 to operate the display panel 510. The driving circuit part 520 includes a data printed circuit board (PCB) 522 that applies data signals to the display panel 510, a gate PCB 524 that applies gate signals to the display panel 510, a data driving circuit film 526 that electrically connects the data PCB 522 to the display panel 510, and a gate driving circuit film 528 that electrically connects the gate PCB 524 to the display panel 510. Each of the data and gate driving circuit films 526 and 528 may include tape carrier packages (TCPs) or chip-on-film packages (COFs). In some embodiments, signal lines may be formed at the display panel 510 and the gate driving circuit film 528, in which case, the gate PCB 524 can be omitted.

The LCD 100 may further include a protective sheet 110 disposed between the light condenser 400 and the display panel 510. The protective sheet 110 is disposed over the light condenser 400 to prevent or reduce any deformation of a condensing pattern formed on an upper surface of the condenser 400, as described below.

As illustrated in FIG. 2, the LCD 100 may further include a reflective sheet 220 disposed below the light source 200. The reflective sheet 220 serves to reflect light emitted downwardly from the light source 200 upward toward the display panel 510 and thereby increase the efficiency of light production.

As illustrated in FIGS. 1 and 2, the LCD 100 may further include a top chassis 120 for securing the display panel 510 in the receiving container 210. The top chassis 120 is combined with the receiving container 210 to form a bezel that covers a peripheral portion of the display panel 510 that does not display an image. The top chassis 120 prevents the display panel 510 from moving about or being damaged by external impacts. The top chassis 120 may be formed in a single body having the shape of a picture frame. Alternatively, the top chassis 120 may include a plurality of separate, elongated channel portions that are assembled into a frame shape.

The LCD 100 may further include an optional mold frame (not illustrated) disposed between the protective sheet 110 and the display panel 510. The mold frame functions to hold the diffusing plate 300, the light condenser 400 and the protective sheet 110 relative to each other in the display, and to support the display panel 510 in the display such that its display surface is correctly oriented.

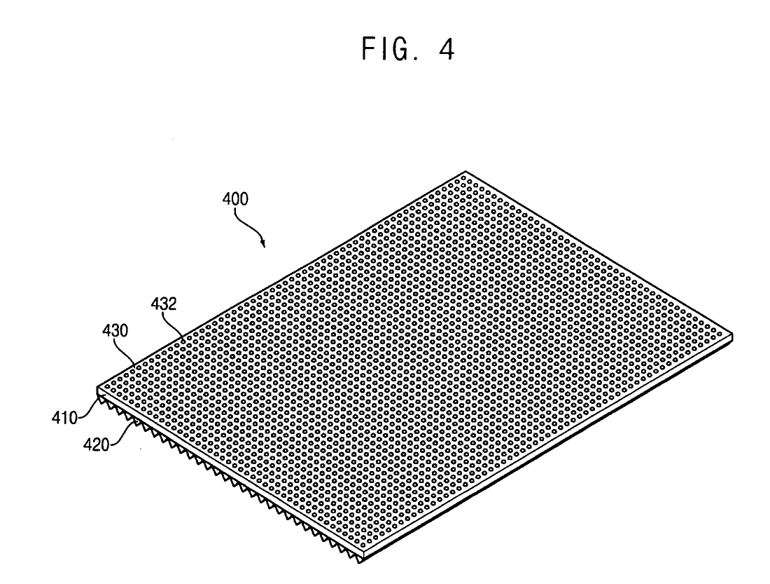

FIG. 3 is a perspective view of the exemplary light condenser of the LCD 100 of FIG. 1, and FIG. 4 is a perspective view of a lower surface thereof. As illustrated in FIGS. 3 and 4, the light condenser 400 includes a base layer 410, a condensing layer 420 formed at an upper surface of the base layer 410, and a lower surface-treated layer 430 formed at the lower surface of the base layer 410.

The base layer 410 comprises a transparent material, such as polyethylene terephthalate (PET), polycarbonate (PC) or the like, for the ready transmission of light therethrough.

The condensing layer 420 is formed on the upper surface of the base layer 410, which faces toward the display panel 510, and has a condensing pattern formed therein that condenses the light passing through it. The condensing pattern may be formed over the entire upper surface of the base layer 410. Rays of light passing through the condensing layer 420 are refracted by the layer to radiate upward in a direction that is substantially perpendicular to the upper surface of the base layer 410.

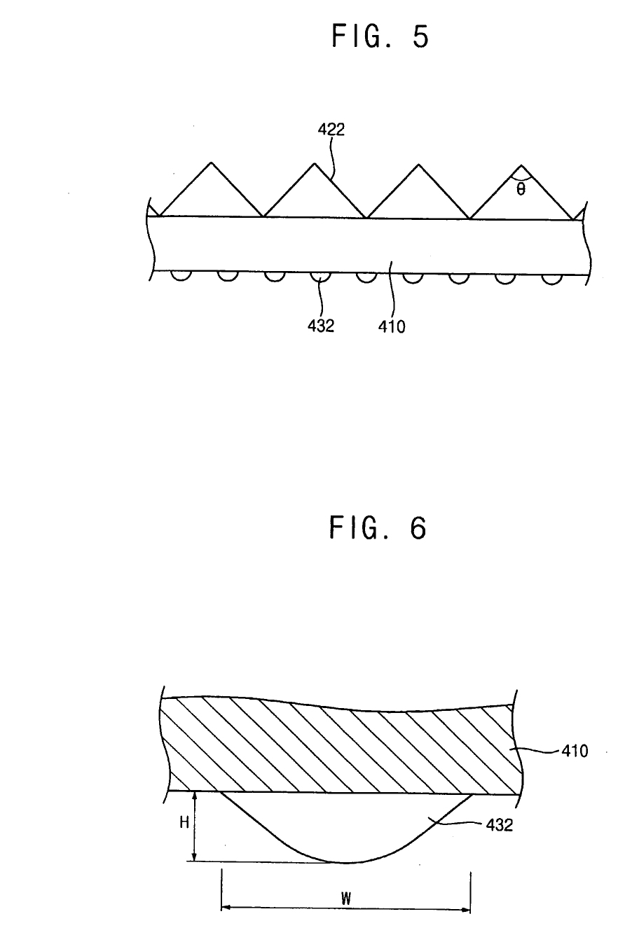

Referring to FIGS. 3 and 5, the condensing pattern comprises a plurality of elongated prisms 422 disposed immediately adjacent to each other on the upper surface of the base layer 410. Each of the prisms 422 has a cross-sectional shape that is substantially triangular. Thus, light rays passing through the backs of the prisms 422 are incident upon the inclined surfaces of the prisms and are thereby refracted upward in a direction that is substantially perpendicular to the upper surface of the base layer 410. The prisms 422 may extend in a direction substantially parallel to the longitudinal direction of the light source 200, or alternatively, may extend in a direction substantially perpendicular to the longitudinal direction of the light source 200.

The condensing layer 420 comprises a transparent material, which may be the same as that of the base layer 410, e.g., polyethylene terephthalate (PET), polycarbonate (PC), or the like. The lower surface-treated layer 430 is formed at a lower surface of the base layer 410 to make contact with the diffusing plate 300, and includes a plurality of bumps or protrusions 432 extending downwardly therefrom and having a substantially round shape. The lower surface-treated layer 430 functions to reduce mutual scratching and adhesion between the light condenser 400 and the diffusing plate 300, thereby increasing the quality of the image of the LCD 100.

The lower surface-treated layer 430 comprises a transparent material, which may be substantially the same as that of the base layer 410, e.g., polyethylene terephthalate (PET), polycarbonate (PC), or the like. The protrusions 432 may be formed over the whole lower surface of the base layer 410. The protrusions 432 may be spaced apart from each other at irregular distances, or alternatively, the protrusions 432 may be spaced apart from each other by regular distances.

FIG. 5 is a cross-sectional view of the light condenser 400 of FIG. 3. Referring to FIG. 5, it can seen that the prisms 422 have a cross-sectional shape which is that of an isosceles or equilateral triangle. The included angel θ at the vertex of each of the prisms 422 is between from about 60° to about 150°, and is preferably about 90°.

Each of the protrusions 432 has a substantially rounded shape that acts like a bearing or spacer to reduce mutual abrasion, or the formation of scratches, with the diffusing plate 300, which is caused by external impacts, as well as the area of adhesion between the two. As will be appreciated, the protrusions 432 may cause some loss of light. Therefore, it is preferable that the shape of each of the protrusions 432 be optimized so as to reduce the light loss resulting from the protrusions, as well as to minimize or prevent any mutual abrasion and/or adhesion between the surface-treated layer 430 and the diffusing plate 300.

FIG. 6 is an enlarged, partial cross-sectional view of one of the protrusions 432 of the light condenser 400 of FIG. 5. Referring to FIG. 6, the protrusion 432 protrudes downwardly from the lower surface of the base layer 410 by a selected height H. The lower end portion of the protrusion 432 has a substantially round shape defining a segment of a sphere. The protrusion 432 has a substantially circular shape having a selected width W when viewed in a plan view. Alternatively, the protrusion 432 may have a substantially oval shape or a substantially polygonal shape when viewed in a plan view.

The physical and optical characteristics of the light condenser 400 depend on the ratio of the height H of the protrusions 432 to their width W. When the ratio of the height H to the width W is excessively great, the end portion of the protrusions 432 become relatively sharp, so that they can easily cause scratching of the underlying diffusing plate 300. On the other hand, when the ratio of the height H to the width W is excessively small, the condenser 400 may easily adhere to the diffusing plate 300. This adherence causes light passing through the interface between the condenser 400 and the diffusing plate 300 to be distorted, thereby adversely affecting the quality of the image produce by the display 100.

It has been discovered that the optimum ratio of the height H to the width W of the protrusions 432 is preferably between about 0.01 to about 0.06. When the curvature of the protrusions 432 increases, the condenser 400 “floats” at a selected height above the diffusing plate 300 without any substantial lateral movement thereof.

Table 1 below illustrates the measured loss of light associated with protrusions 432 having various H/W ratios.

TABLE 1

| Example | Height (μm) | Width (μm) | Density (/mm²) | Light Loss (%) |
|---|---|---|---|---|
| 1 | 10 to 16 | 100 to 150 | — | 8 |
| 2 | 1.2 | 34 | 450 | 3 |
| 3 | 0.43 | 29 | 540 | 3 |
| 4 | 2.1 | 1.62 | 1200 | 4 |
| 5 | 2.3 | 17.6 | 2000 | 5 |

Referring to Table 1, it will be noted that the light loss caused by the protrusions 432 depends primarily on the height H of the protrusions 432. In Example 1, for instance, the height H of the protrusions 432 was relatively large in comparison with the respective heights H of the protrusions 432 in Examples 2 to 5, and that the light loss of the protrusions in Example 1 was relatively much greater than those of the latter Examples. Further, it was observed that, when the height H of the protrusions 432 was made excessively small, the sharpness of the lower ends of the protrusions more readily caused scratching and abrasions of the diffusing plate. Thus, the height H of the protrusions 432 is preferably between about 1 μm to about 10 μm (where 1 μm=1×10⁻⁶ meter) in order to reduce the likelihood of their causing scratches and to minimize light loss. More preferably, the height H of the protrusions 432 is about 2 μm.

The width W of the protrusions 432 depends on the height H of the protrusions 432 within the preferred range of ratios of the height H to the width W. For example, when the height H of the protrusion 432 is about 2 μm, the width W of the protrusion 432 is preferably about 33 μm to about 50 μm.

The loss of light caused by the protrusions 432 also depends on the density of the protrusion 432 on the lower surface of the base layer 410. It was observed that the problem of adhesion between the condenser 400 and the diffusing 300 plate did not occur in Examples 2 to 5, and accordingly, the density of the protrusions 432 is preferably no less than 450 protrusions per square millimeter (450/mm²). Referring to Examples 4 and 5, it may be seen that when the density of the protrusions 432 increases, the light loss also increases. Accordingly, the density of the protrusions 432 is preferably no greater than about 1000 protrusions/mm².

An exemplary embodiment of a method for manufacturing a light condenser 400 in accordance with the present invention is described below with reference to FIGS. 3 to 6. Referring to FIG. 3, the condensing layer 420 is formed on the base layer 410. The condensing layer 420 has the condensing pattern, including the prisms 422 with substantially triangular cross-sections. The condensing pattern 420 may be formed in a rolling process using a master roller that has a pattern complementary to that of the condensing pattern, or alternatively, in a pressing process that uses a press having a pattern complementary to that of the condensing pattern. Additionally, the condensing pattern may be formed by a photolithography process, a laser ablation process, or by a number of other known processes.

Referring to FIG. 4, the lower surface-treated layer 430 is formed below the base layer 430 to include a plurality of the downwardly extending protrusions 432. As above, each of the protrusions 432 has a substantially round shape. The protrusions 432 may be formed, for example, by a sand-blasting process. In particular, the protrusions 432 may be formed by blasting small particles, such as sand, using compressed air. Alternatively, the protrusions 432 may be formed through a photolithography process, a stamping process, or the like. The lower surface-treated layer 430 may be formed either before or after the condensing layer 420 is formed.

In the above exemplary embodiments, the LCD light condenser of the present invention performs the functions of several other optical elements. Therefore, its use enables the number of optical elements needed in the LCD to be reduced, thereby reducing LCD manufacturing costs. Additionally, the light condenser is more resistant to the problem of mutual scratching and adhesion between the condenser and the diffusing plate, thereby improving the quality of the image produced by the display. Further, the shape of the protrusions on the lower surface-treated layer can be optimized to minimize the loss of light caused by the protrusions.

By now, those of skill in this art will appreciate that many modifications, substitutions and variations can be made in and to the spacer printing methods and apparatus of the present invention and their advantageous application to the manufacture of LCD substrates without departing from its spirit and scope. In light of this, the scope of the present invention should not be limited to that of the particular embodiments illustrated and described herein, as they are only exemplary in nature, but instead, should be fully commensurate with that of the claims appended hereafter and their functional equivalents.

What is claimed is:

1. A light condenser for an LCD, comprising:
a base layer;
a condensing layer formed on the base layer; and,
a lower surface-treated layer below the base layer, comprising a plurality of downwardly extending protrusions, each having a substantially round shape.

2. The condenser of claim 1, wherein each of the protrusions has a height and a width, and wherein the ratio of the height to the width of each protrusion is from about 0.01 to about 0.06.

3. The condenser of claim 2, wherein each protrusion has a height of from about 1 μm to about 10 μm.

4. The condenser of claim 2, wherein the density of the protrusions on the lower surface-treated layer is from about 450/mm² to about 1000/mm².

5. The condenser of claim 2, wherein the protrusions are spaced apart from each other at irregular distances.

6. The condenser of claim 3, wherein the base layer, the condensing layer and the lower surface-treated layer comprise polyethylene terephthalate, polycarbonate, or both polyethylene terephthalate and polycarbonate.

7. A method of manufacturing a light condenser for an LCD, the method comprising:
forming a condensing layer having a plurality of prisms disposed on a base layer; and,
forming a lower surface-treated layer having a plurality of protrusions extending downward from the base layer, each of the protrusions having a substantially round shape.

8. The method of claim 7, wherein the lower surface-treated layer is formed by a sand-blasting process.

9. The method of claim 7, wherein the lower surface-treated layer is formed by a photolithography process.

10. The method of claim 7, wherein each protrusion has a height and a width, and wherein the ratio of the height to the width of each protrusion is from about 0.01 to about 0.06.

11. The method of claim 10, wherein the height of each protrusion is from about 1 μm to about 10 μm.

12. The method of claim 10, wherein the density of the protrusions on the lower surface-treated layer is from about 450/mm² to about 1000/mm².

13. An LCD, comprising:
a light source for generating light;
a diffusing plate disposed on the light source;
a light condenser disposed on the diffusing plate and comprising a base layer, a condensing layer disposed on the base layer, and a lower surface-treated layer disposed below the base layer, the condensing layer having a condensing pattern formed therein, the lower surface-treated layer having a plurality of protrusions thereon, each of the protrusions having a substantially round shape; and,
a display panel disposed above the condenser for displaying an image.

14. The LCD of claim 13, wherein the ratio of a height of the protrusions to a width of the protrusion is from about 0.01 to about 0.06.

15. The LCD of claim 14, wherein the height of the protrusion is from about 1 μm to about 10 μm.

16. The LCD of claim 15, wherein a density of the protrusions is from about 450/mm² to about 1000/m².

17. The LCD of claim 13, further comprising a protective sheet disposed between the condensing layer and the display panel.
